(19) United States
(12) Patent Application Publication
(10) Pub. No.: US 2023/0304909 A1
(43) Pub. Date: Sep. 28, 2023

(54) Method of characterizing the properties of a surface

(71) Applicant: Aalto University Foundation SR, Aalto (FI)

(72) Inventors: Jaakko Timonen, Espoo (FI); Robin Ras, Espoo (FI); Mika Latikka, Espoo (FI)

(21) Appl. No.: 18/022,178

(22) PCT Filed: Aug. 19, 2020
(86) PCT No.: PCT/FI2020/050542

§ 371 Date: Feb. 20, 2023

(51) Int. Cl. G01N 13/02

(52) U.S. Cl. CPC G01N 13/02

(57) ABSTRACT

A method of determining surface properties of interest of a surface. The method comprises providing a magnetic liquid and applying it onto a part of the surface in the form of a droplet. The droplet contacts the surface and it is subjected to a magnetic field. The lateral position of the magnetic field maximum is changed relative to the surface to drag the drop magnetically along a predetermined length of the surface following a path. The retentive force exerted on the droplet during its movement is measured in order to collect data as the drop moves along the surface, and the surface properties of interest are determined from the collected data. The method can be used for studying wetting properties and, in one embodiment, the method is used for assessing homogeneity and potential contamination of a surface.

### FIELD OF THE INVENTION

The present invention relates to a method of characterizing the properties of a surface.

More specifically, the present invention concerns a method of characterization of properties of interest of surfaces by using magnetic liquids.

### BACKGROUND

Hydrophobic surfaces, or water-repellent surfaces, including superhydrophobic surfaces, can be used in applications where properties of staying dry, self-cleaning, anti-icing, antifogging and fluid drag reduction are being sought. Slippery surfaces, which are usually infused with a lubricating liquid, show similar properties. To develop these surfaces, there is a need for methods that can be used for determining the properties of the surfaces. Various techniques have been developed.

Wetting properties of slippery and conventional hydrophobic surfaces can be studied using contact angle goniometry. However, goniometry technique does not allow for accurate investigation of superhydrophobic surfaces.

There is a need for new methods for reliable assessment and potentially mapping of e.g. wetting properties of a wide range of slippery and hydrophobic surfaces, including superhydrophobic surfaces.

### SUMMARY OF THE INVENTION

It is an aim of the present invention to provide a novel method of studying hydrophobic and slippery surfaces, in particular for characterizing their wetting properties.

The present invention is based on the concept of providing a magnetic liquid which can be applied onto a part, in particular a discrete area, of the surface in the form of a droplet. The droplet is subjected to magnetic field, in particular an inhomogeneous magnetic field, the main magnet axis of which preferably is essentially perpendicular to the surface at the area supporting the droplet and the strength of which is highest at the droplet location.

By changing the lateral position of the magnetic field maximum relative to the surface it is possible to drag the droplet along a predetermined length of the surface. During the movement of the droplet along the surface, the retentive force exerted by the droplet, at a plurality of discrete areas of the surface, is measured. The surface properties of interest are determined from the collected data of the retentive force.

More specifically, the present invention is mainly characterized by what is stated in the characterizing part of claim 1.

The present invention provides for a technique of non-destructive assessment of surface properties, such as measuring wetting inhomogeneities, as well as characterizing other surface properties of interest of a surface, using magnetically controlled water-like droplets over the entire length of the samples.

The technique can be used for studying both planar surfaces as well as non-planar (curved, conical).

The present technique is suitable for in quality control of surfaces and applicable to hydrophobic, superhydrophobic and slippery surfaces of inorganic and organic materials, as well as to biological surfaces. The technique can be used in research and development as well as in quality control at the production site.

Next, embodiments will be examined with the aid of drawings.

### BRIEF DESCRIPTION OF THE DRAWINGS

FIG. 1 is a simplified depiction of an embodiment;

FIG. 2 shows how, in one embodiment, a scanning droplet tribometer can be used for assessing surface smoothness or wettability; and

FIGS. 3a and 3b show curve of Dissipation Forces as a function of time: FIG. 3a shows the dissipation forces (in newton) as a function of time (in seconds) for a typical measurement with the scanning droplet tribometer, and FIG. 3b shows a magnification of the rectangle in FIG. 3a.

### EMBODIMENTS

In the present context, the term “characterizing”, when used with regard to properties of a surface, is used synonymously with “assessing” or “determining”.

In the present context, the term “properties of interest” designates properties that are being studied.

In the present context, the term “magnetic liquid” stands for a fluid that comprises, consists of, or consists essentially of nanoparticles and a carrier liquid. Further, encompassed by the term are also fluids that comprise, consist of, or consist essentially of paramagnetic salts dissolved in a carrier liquid.

“Carrier liquid” stands for a medium in which the nanoparticles are dispersed. The carrier liquids can be protic or aprotic liquids, in particular polar liquids, such as water or alcohols or combinations thereof, optionally containing dissolved salts, or non-polar liquids, such as hydrocarbon liquids, such as alkanes.

Typically, the nanoparticles are selected from the group of “superparamagnetic particles”.

As conventional, for the purpose of the present invention, “superparamagnetic particles” are nanoparticles, in particular nanoparticles of ferromagnetic or ferrimagnetic materials, having a size which allows for their magnetization to randomly flip direction under the influence of temperature. When measuring the average magnetization of such particles—in the absence of an external field—it appears to be zero, provided that the measuring time is much longer than the relaxation time, i.e., the time between two flips.

In one embodiment, the present nanoparticles comprise ferromagnetic or ferrimagnetic materials selected from the group of iron, cobalt, nickel, ferrite and manganese and combinations thereof.

“Hydrophobic” surfaces are surfaces which have a water contact angle of more than 60°, in particular 80° or more. Typically, many hydrophobic surfaces—in particular engineering hydrophobic surfaces—have contact angles in the range from about 80° to about 120° (such surfaces may comprise polymeric materials, such as polystyrene and poly(tetrafluoro ethylene)).

Further, there are also surfaces having contact angles of about 120° or more.

In the present context, “superhydrophobic surfaces” are surfaces that achieve high contact angle and low roll-off angle by trapping air within the topographical structures, so that the liquid droplet is mostly in contact with air and very little with the solid surface.

Typically, superhydrophobic surfaces have an apparent contact angle (θ*) greater than 150°, and a roll-off angle (θ_{roll-off}) of less than 10°.

In the present context, “slippery” surfaces are surfaces with low roll-off angles, which is typically achieved by infusing the surface with a lubricating liquid. The lubricating liquid prevents a droplet of immiscible liquid from pinning to the solid surface, allowing it to move easily on the surface. Unlike hydrophobic surfaces, slippery surfaces can have low contact angles, typically below 50°.

The “average particle size” can be determined with a transmission electron microscope. The standard deviation with respect to the average particle size is given as a geometric standard deviation.

In an embodiment, the method comprises providing a magnetic liquid, and applying the magnetic liquid onto a discrete area of the surface in the form of a droplet. The droplet, which contacts at least a part of the surface in said discrete area is then subjected to a magnetic field, in particular an inhomogeneous magnetic field.

Typically, the main magnet axis of the magnetic field is perpendicular or essentially perpendicular to the surface at the area which supports the droplet. The strength of the magnetic field is highest at the magnet axis. The droplet can be slightly displaced from the field maximum.

In another embodiment, the droplet is subjected to an inhomogeneous magnetic field, the main magnet axis of which is essentially perpendicular to the surface at the area supporting the droplet and the strength of which is highest at the magnet axis.

By changing the lateral position of the magnetic field maximum relative to the surface the droplet is dragged along a predetermined length of the surface typically following a predetermined path.

One embodiment comprises moving the magnetic field laterally along the surface at constant velocity, in particular a velocity in the range of 0.1 to 10 mm/s.

The retentive force exerted on the droplet during its movement along the length of the surface is measured in order to collect data on the retentive force at a plurality of discrete areas of the surface. The retentive force opposes the droplet's movement, at the same time the droplet also exerts an opposing force to the surface.

In one embodiment, the retentive force is determined from the distance between droplet and the field maximum. In one embodiment, this determination is carried out optically, for example using a video camera and image analysis. In one embodiment, this determination is carried out by an optical distance probe, such as laser triangulation or laser sheet or laser gate analysis.

In one embodiment, the collected data on the retentive force—used for the assessment of the surface property or properties of interest—comprises data obtained by continuous measurement of the distance between the droplet and the field maximum, the distance typically being measured between the vertical axis of the magnet(s) and the center of the droplet.

The present technology allows for the use of a scanning droplet tribometer for analyzing surfaces. The technology allows for resolving properties across the surface by scanning analysis. Typically, the technology allows for surface scanning with a spatial resolution from 0.01 to 1 mm.

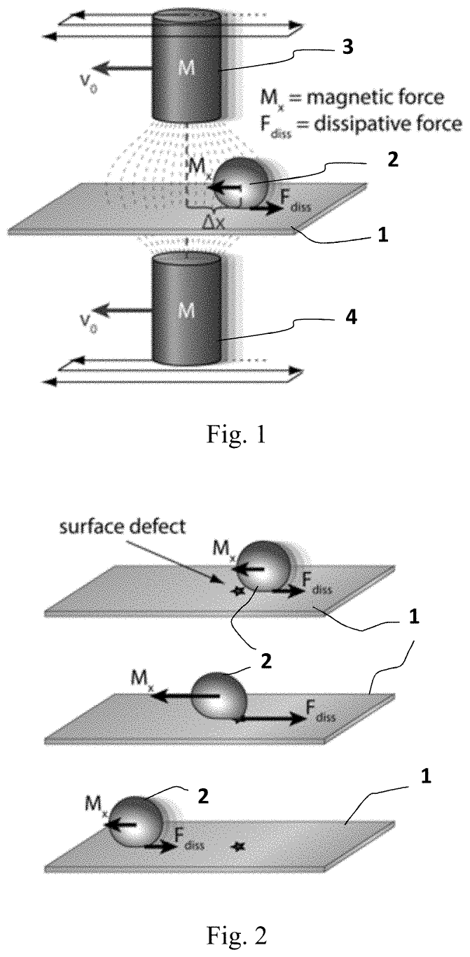

The principle of the operation of a scanning droplet tribometer according to one embodiment is shown in FIGS. 1 and 2.

As will be apparent from FIG. 1, a droplet 2 placed on a surface 1 is subjected to a magnetic field caused by magnets, such as cylindrical permanent magnets 3, 4. The magnets, and hence the magnetic field, are moved horizontally at a constant velocity v₀, pulling the magnetic droplet along. The distance between the magnets' vertical axis and the center of the droplet Δx depends on the pulling magnetic force Mₓ and dissipative force F_{diss}.

One embodiment for determining the dissipative force related to the contact angle hysteresis is discussed below in more detail.

FIG. 2 illustrates the use of a scanning droplet tribometer of the kind disclosed in FIG. 1 for studying a surface. Thus, a magnetically controlled droplet 2 is used for detecting a defect (marked with a star) on a surface 1. Such a defect can comprise inhomogeneities in the chemical or physical composition of the surface, or a roughness in the surface which might locally change the wetting behavior of the surface. The defect can also

In the embodiment, the dissipation forces exerted on the droplet by the magnetic force induced by the magnets 3, 4 is measured. When the moving droplet 2 encounters a surface defect (cf. top image of FIG. 2), its receding edge gets pinned to the surface and an increased force is required to free the droplet (cf. center image of FIG. 2). After the droplet is detached from the defect, it continues to follow the magnet (cf. bottom image of FIG. 2).

As will appear from the drawings, in one embodiment there are two magnets 3, 4, one on each opposite side of the surface, and the droplet is subjected to the magnetic field extending between the magnets.

The magnet(s) 3, 4 used is (are) permanent magnets or electromagnets or combinations thereof.

As mentioned above, the surface and the magnets are subjected to relative motion. Such a motion can be achieved by continuously moving the magnetic field relative to the surface in order to drag the droplet along the surface.

In one embodiment, the relative movement between the surface and the magnet can be achieved by continuously moving the magnet(s) laterally in a direction substantially parallel to the surface. In another embodiment, the relative movement between the surface and the magnet is achieved by continuously moving the surface laterally with respect to magnet(s) which is (are) in a stationary position.

One embodiment comprises measuring as a maximum retentive force a dissipative force related to the contact angle hysteresis F_{CAH} at the three-phase contact line L of the drop when the droplet is pinned to the surface.

In such a method, the contact angle hysteresis is determined as the difference between the advancing contact angle (θ_{Adv}) and the receding contact angle (θ_{Rec}), when subjecting the drop with a volume of V to the relative movement of the magnetic field H inducing magnetic force Mₓ according to formula I

0=Mₓ−F_{CAH}=μ₀VM∇H−kLγ(cos(θ_{Rec})−cos(θ_{Adv}))

wherein

μ₀ is the vacuum permeability

M is the average droplet magnetization,

k is a constant related to droplet shape and

γ is the surface tension.

Thus, the retentive force is related to contact angle hysteresis. As will appear, when the droplet is pinned, the magnetic force is equal to the retentive force.

As the magnets 3, 4 move, the magnetic force increases, until the droplet starts to move again. The maximum retentive force (before the droplet starts to move) equals the contact angle hysteresis force.

In one embodiment, the magnetic liquid is subjected to a magnetic field of about 250 to 5000 Oe, in particular 500 to 2400 Oe, at room temperature.

One embodiment comprises subjecting the droplet to a magnetic field exerting horizontal forces on the droplet, while exerting essentially no vertical magnetic forces such that the normal force and droplet shape are left unaffected.

FIG. 2 also shows a scanning mode application, in which the droplet is moved along the surface in direction x to-and-from so as to transverse the full breadth of the surface in direction y to allow for complete xy scan of the surface.

Thus, one embodiment comprises dragging the droplet along a linear path on the surface. Further, one embodiment, comprises dragging the droplet along several essentially parallel linear paths on the surface to allow for spatial scanning of the surface for its properties.

In one embodiment, which can be combined with any of the above, the magnetic liquid forming the droplet 2 comprises a liquid carrier containing suspended superparamagnetic nanoparticles. Such magnetic liquids can also be referred to as ferrofluids.

In one embodiment, the superparamagnetic nanoparticles are made of any ferromagnetic or ferrimagnetic material, such as iron, cobalt, nickel, ferrite or manganese.

In one embodiment, the magnetic liquid comprises a suspension, in particular a colloidal suspension, of a dispersion medium and dispersed particles.

In one embodiment, the magnetic liquid comprises a paramagnetic salt solution. Examples of such solutions include aqueous solutions of holmium nitrate and gadolinium nitrate. The concentration of such salts is typically about 0.1 to 10 wt-%, for example about 0.5 to 5 wt-%.

Preferably, the dispersion or solvent medium (or “carrier”) is selected from protic and aprotic liquids, in particular polar liquids, such as water or alcohols or combinations thereof, optionally containing dissolved salts, or non-polar liquids, such as hydrocarbon liquids, such as alkanes.

The carrier may contain alkali metal or earth alkaline metal halogenides, such as chlorides. Further, the carrier may contain nitrates and phosphate anions, such as phosphates for buffering the pH of the carrier.

The composition of the magnetic liquid is typically such that the particles suspended therein are stable, i.e. they do not aggregate.

The pH of the carrier is not critical; it can vary in the range from strongly acidic (pH of about 1) to strongly alkaline (pH of about 14). Preferably, the carrier is selected such that it is inert or essentially inert with regard to the studied surface to avoid or minimize chemical interaction between the magnetic liquid and the surface.

In one embodiment, the carrier exhibits a pH in the neutral range, or generally in the range from about 6 to about 8., for example about 7.

In one embodiment, the magnetic liquid is a stable suspension of magnetite nanoparticles in a carrier liquid at a concentration of up to 25 vol-%. Typically, the concentration of nanoparticles is about 0.1 to about 10 vol-%, for example 0.5 to 5 vol-%.

In one embodiment, the magnetic liquid is a ferrofluid containing a stabilizer preventing aggregation of the nanoparticles and promoting their dispersion in the liquid.

In one embodiment, the magnetic liquid contains particles having an average particle size in the range from ca. 5 nm with a geometric standard deviation of 2 nm up to ca. 15 nm with a geometric standard deviation of 5 nm.

In one embodiment, magnetic liquid is an aqueous ferrofluid having an average surface tension of 65±0.1 mN/m to 75±0.1 mN/m. It has been found that for nanoparticles having an average particle size of up to 15 nm and a concentration of no more than 25 vol-%, or for example in the range of about 0.1 to about 10 vol-%, or 0.5 to 5 vol-%, the surface tension of the magnetic fluid is on the same order as that of pure water.

In one embodiment, the nanoparticles are electrostatically stabilized particles. As a result, the surface tension of the magnetic fluid is time-independent. The nanoparticles do not have the tendency to migrate to the surface.

In one embodiment the method is used for assessing surface properties, such as wetting properties, using two different magnetic liquids, in particular ferrofluids of superparamagnetic nanoparticles. The ferrofluids may differ with regard to the kind or size of the nanoparticles or with regard to the carrier liquid composition. By using two different fluids sensitivity of the surface analysis can be improved.

In the following, a non-limiting example is disclosed.

### EXAMPLES

Ferrofluids comprising suspensions of magnetite nanoparticles were prepared.

Magnetite nanoparticles were synthesized by coprecipitation of an aqueous mixture of ferric chloride (FeCl₃ 6H₂O) and ferrous chloride (FeCl₂ 4H₂O) (mixture ratio FeCl₃/FeCl₂=2:1). The nanoparticles were precipitated by adding ammonia (NH₄OH) in ambient conditions and stabilized with citric acid near pH 7. The resulting solution was washed several times with Milli-Q water and acetone using magnetic decantation. The solution was left to evaporate in room temperature until the density was close to 2 g/ml, corresponding nanoparticle concentration of approximately 20 vol-%.

The test liquid with 2 vol-% nanoparticle concentration was achieved by diluting the concentrated ferrofluid with milli-Q water. The average nanoparticle size was determined to be 4.6 nm with a geometric standard deviation of 1.4 nm using transmission electron microscopy (JEOL JEM-2200F, 200 kV).

The magnetic properties of the 2 vol-% iron oxide nanoparticle dispersions were measured with a magnetometer (Quantum Design MPMS XL7). No magnetic hysteresis was detected within experimental accuracy.

The surface tension of the ferrofluid was 71.6±0.03 mN/m. The surface tension remained constant during the measurements, suggesting that the nanoparticles do not adsorb on the liquid-air interface.

The ferrofluid was used for assessing the internal surface of a tapered polypropylene tube using the following test procedure: a 1.5 μL ferrofluid droplet was pipetted inside the sample near the large opening. The tube was attached to a sample holder so that the droplet was on the axis of the two magnets. The magnets were moved with a computer controlled linear stage at a speed of 1 mm/s for 35 mm and back. The droplet position was recorded using a video camera (resolution 1920×1080 pixels, framerate 60 fps). The measurements were repeated at least 3 times using the same ferrofluid droplet. Custom Matlab functions were used to extract the droplet's position and distance to the magnets' axis as a function of time from the recorded video.

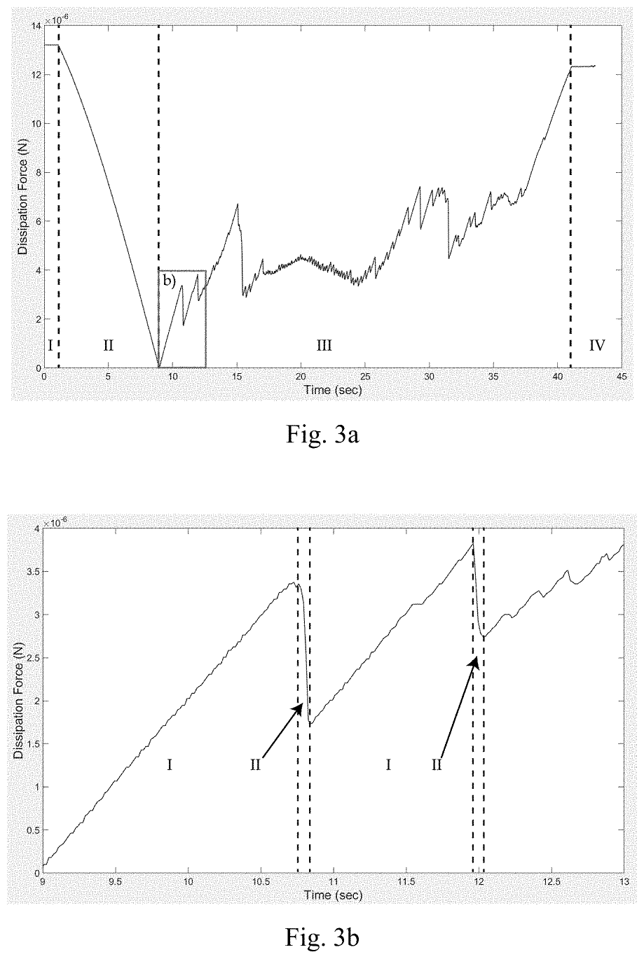

FIG. 3a shows the dissipation force as a function of time as the ferrofluid droplet is moved from the large opening to the small. There are four distinct regimes in the droplet movement:

1. The video recording is started while both the ferrofluid droplet and the magnets remain stationary.

2. The magnets are moved with the linear stage towards the droplet. When the magnets' axis reach the center of the droplet, the magnetic force equals to 0 N.

3. The magnets continue past the droplet. As the magnetic force increases, the droplet depins from the surface and starts to follow the magnets in a stick-slip motion. The droplet position relative to the magnets' axis is recorded and used for analyzing the surface.

4. The droplet reaches the end of the tube and the magnets are stopped.

The rectangle in FIG. 3a is magnified in FIG. 3b, showing two regimes:

1. The droplet is pinned to the surface by the retention force and remains stationary. As the magnets continue to move further away from the droplet, the magnetic force is increased.

In this regime, the magnetic force equals the retention force acting on the three-phase contact line. This retention force reaches maximum right before the droplet starts to move again. The maximum retention force equals the contact angle hysteresis force, which is used to quantify local surface wetting properties.

2. The magnetic force overcomes the contact angle hysteresis force and the droplet starts to move. In this regime the dissipative force is a sum of contact angle hysteresis force and viscous dissipation force, which is proportional to droplet velocity.

As the droplet moves closer to the magnets' axis, the magnetic force is decreased. The droplet pins again to the surface when the contact angle hysteresis force becomes higher than the magnetic force.

Based on the above, an embodiment of the present technique comprises providing a magnetic liquid and applying it onto a part of the surface in the form of a droplet. The droplet contacts the surface and it is subjected to a magnetic field. The lateral position of the magnetic field maximum is changed relative to the surface to drag the drop magnetically along a predetermined length of the surface following a path. The retentive force exerted on the droplet during its movement is measured in order to collect data as the drop moves along the surface, and the surface properties of interest are determined from the collected data.

The method can be used generally for studying wetting properties, including self-cleaning, anti-icing, antifogging and fluid drag reduction properties and, in one embodiment, the method is used for assessing homogeneity and potential contamination of a surface.

It is to be understood that the embodiments of the invention disclosed are not limited to the particular structures, process steps, or materials disclosed herein, but are extended to equivalents thereof as would be recognized by those ordinarily skilled in the relevant arts.

It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

### INDUSTRIAL APPLICABILITY

The present method as disclosed above for example in the various embodiments, can be used generally for determining the wetting properties of the surface. In particular, the method can be used for determining properties selected from the group of self-cleaning, anti-icing, antifogging and fluid drag reduction. In one embodiment, the method is used for determining homogeneity and potential contamination of a surface.

The surface is typically a hydrophobic surface, a superhydrophobic surface or a slippery surface.

The surface can be comprised of a number of materials, including inorganic materials, including metal or semimetal oxide materials, polymeric materials, such as thermoplastic materials, thermoset materials or polymer composites, or biological materials, such as organic surfaces comprising of cells or peptides or amino acids and materials thereof.

The surface can be planar. In one embodiment, the surface is a bent or curved surface, for example as a non-planar surface of a hollow structure. Examples of such non-planar surfaces include the inner surface of a tube, for example a transparent tube, optionally having a tubular or conical inner surface.

The technique can be used in research and development as well as in quality control at production sites.

1. A method of characterizing surface properties of a surface, comprising the steps of
providing a magnetic liquid;
applying the magnetic liquid onto a discrete area of the surface in the form of a droplet, said droplet contacting at least a part of the surface in said discrete area;
subjecting the droplet to a magnetic field having a maximum;
changing the lateral position of the magnetic field maximum relative to the surface to drag the drop magnetically along a predetermined length of the surface;
measuring the retentive force exerted on the droplet during its movement along the predetermined length of the surface in order to collect data on the retentive force at a plurality of discrete areas of the surface; and
determining said surface properties from the collected data of the retentive force.

2. The method according to claim 1, wherein the droplet is subjected to a magnetic field, in particular an inhomogeneous magnetic field, the main magnet axis of which is essentially perpendicular to the surface at the area supporting the droplet and the strength of which is highest at the magnet axis.

3. The method according to claim 1, wherein the droplet is subjected to a magnetic field, main magnet axis of which is essentially parallel to the surface at the area supporting the droplet.

4. The method according to any of claims 1 to 3, wherein the retentive force is determined from the distance between droplet, in particular the center of the droplet, and the field maximum.

5. The method according to claim 4, wherein the retentive force is determined optically, for example using a video camera and image analysis.

6. The method according to claim 4 or 5, wherein the retentive force is determined optically by an optical distance probe, such as laser triangulation or laser sheet or laser gate analysis.

7. The method according to any of the preceding claims, wherein the collected data on the retentive force comprises data obtained by continuous measurement of the distance between the droplet and the field maximum.

8. The method according to any of the preceding claims, wherein the magnetic liquid comprises a ferrofluid containing superparamagnetic nanoparticles or a magnetic liquid comprising a solution of paramagnetic salts.

9. The method according to any of the preceding claims, wherein the superparamagnetic nanoparticles are made of any ferromagnetic or ferrimagnetic material, such as iron, cobalt, nickel, ferrite or manganese.

10. The method according to claim 8 or 9, wherein the paramagnetic salts are selected from the group of holmium nitrate and gadolinium nitrate and combinations thereof.

11. The method according to any of the preceding claims, wherein the magnetic liquid comprises a suspension of a dispersion medium and dispersed particles, said dispersion medium being selected from protic and aprotic liquids, in particular polar liquids, such as water or alcohols or combinations thereof, optionally containing dissolved salts, or non-polar liquids, such as hydrocarbon liquids, such as alkanes.

12. The method according to any of the preceding claims, wherein the magnetic liquid is a stable suspension of magnetite nanoparticles in a carrier liquid at a concentration of up to 25 vol-%, for example in the range of about 0.1 to about 10 vol-%, such as 0.5 to 5 vol-%.

13. The method according to any of the preceding claims, wherein the magnetic liquid is a ferrofluid containing a stabilizer for reducing or preventing aggregation of the nanoparticles and promoting their dispersion in the liquid.

14. The method according to any of the preceding claims, wherein the magnetic liquid is a ferrofluid contains particles having an average particle size in the range from ca. 5 nm with a geometric standard deviation of 2 nm up to ca. 15 nm with a geometric standard deviation of 5 nm.

15. The method according to any of the preceding claims, wherein the magnetic liquid is an aqueous ferrofluid having an average surface tension of 65±0.1 mN/m to 75±0.1 mN/m, preferably the aqueous ferrofluid has a surface tension equal to or close to pure water.

16. The method according to any of the preceding claims, wherein the magnetic liquid is subjected to a magnetic field of 500 to 2400 Oe, at room temperature.

17. The method according to any of the preceding claims, comprising subjecting the droplet to a magnetic field exerting horizontal forces on the droplet, while exerting essentially no vertical magnetic forces such that the normal force and droplet shape are left unaffected.

18. The method according to any of the preceding claims, comprising measuring as a maximum retentive force a dissipative force related to the contact angle hysteresis F_{CAH} at the three-phase contact line L of the drop when the droplet is pinned to the surface.

19. The method according to claim 18, wherein the contact angle hysteresis is determined as the difference between the advancing contact angle (θ_{Adv}) and the receding contact angle (θ_{Rec}), when subjecting the drop with a volume of V to the relative movement of the magnetic field H inducing magnetic force Mₓ according to formula I
0=Mₓ−F_{CAH}=μ₀VM∇H−kLγ(cos(θ_{Rec})−cos(θ_{Adv}))
wherein
μ₀ is the vacuum permeability
M is the average droplet magnetization,
k is a constant related to droplet shape and
γ is the surface tension.

20. The method according to any of the preceding claims, comprising providing two magnets, one on each opposite side of the surface, and subjecting the drop to the magnetic field extending between the magnets.

21. The method according to any of the preceding claims, wherein the magnet is a permanent magnet or an electromagnet.

22. The method according to any of the preceding claims, comprising continuously moving the magnetic field relative to the surface in order to drag the droplet along the surface.

23. The method according to any of the preceding claims, wherein the relative movement between the surface and the magnet is achieved by continuously moving the magnet(s) laterally in a direction substantially parallel to the surface.

24. The method according to any of the preceding claims, wherein the relative movement between the surface and the magnet is achieved by continuously moving the surface laterally with respect to magnet(s) which is (are) in a stationary position.

25. The method according to any of the preceding claims, comprising measuring the retentive force for drops of at least two different ferrofluids.

26. The method according to any of the preceding claims, comprising dragging the droplet along a linear path on the surface.

27. The method according to any of the preceding claims, comprising moving the magnetic field laterally along the surface at constant velocity, in particular a velocity in the range of 0.1 to 10 mm/s.

28. The method according to any of the preceding claims, comprising dragging the droplet along several essentially parallel linear paths on the surface to allow for spatial scanning of the surface for its properties.

29. The method according to any of the preceding claims, comprising determining the wetting properties of the surface.

30. The method according to any of the preceding claims, comprising characterizing surface properties of interest of a surface, selected from the group of self-cleaning, anti-icing, antifogging and fluid drag reduction.

31. The method according to any of the preceding claims, comprising investigating homogeneity and potential contamination of a surface.

32. The method according to any of the preceding claims, wherein the surface is a hydrophobic surface, a superhydrophobic surface or a slippery surface.

33. The method according to any of the preceding claims, wherein the surface is a hollow, non-planar surface, such as the inner surface of a tube, for example a transparent tube, optionally having a tubular or conical inner surface.
